(19) United States
(12) Patent Application Publication
(10) Pub. No.: US 2014/0259083 A1
(43) Pub. Date: Sep. 11, 2014

(54) SYSTEM AND METHOD FOR USE IN ENHANCING THE DISPLAY OF MULTIMEDIA CONTENT

(71) Applicants: Brant Candelore, San Diego, CA (US); Graham Clift, Poway, CA (US); Kazumoto Kondo, San Diego, CA (US); Steven Richman, San Diego, CA (US); Fred Zustak, Poway, CA (US)

(72) Inventors: Brant Candelore, San Diego, CA (US); Graham Clift, Poway, CA (US); Kazumoto Kondo, San Diego, CA (US); Steven Richman, San Diego, CA (US); Fred Zustak, Poway, CA (US)

(21) Appl. No.: 13/794,386

(22) Filed: Mar. 11, 2013

(51) Int. Cl. H04N 21/462

(52) U.S. Cl. CPC H04N 21/4622
USPC 725/110

(57) ABSTRACT

Some embodiments provide methods of displaying content comprising: receiving, through a user agent of a web browser application implemented on a television, web content comprising an option defined within the web content to cause the retrieval and playback of additional multimedia content; activating a first canvas and displaying the web content in the first canvas; detecting an activation of the option; retrieving the additional multimedia content; intercepting the additional multimedia content and preventing the additional multimedia content from being displayed within the first canvas; activating a second canvas; and playing back, on the television and in response to the detection of the activation of the option, the additional multimedia content within the second canvas while the web content continues to be displayed within the first canvas such that both the first canvas and the second canvas are active and displayed simultaneously.

### BACKGROUND

1. Field of the Invention

The present invention relates generally to displaying content, and more specifically to displaying content through a television.

2. Discussion of the Related Art

Televisions continue to improve. For example, televisions provide increased numbers of pixels and resolution and improved user experiences. The increased resolutions provide sharper picture quality. Further, televisions are being provided with greater processing capabilities.

Users continue to consume large amounts to programming and advertising. Additionally, users are utilizing their televisions to acquire additional types of content that were not typically accessed through the television even as much as a decade ago.

### SUMMARY OF THE INVENTION

Several embodiments of the invention advantageously address the needs above as well as other needs by providing methods displaying content. In some embodiments, methods of displaying content comprise: receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; activating, by the user agent, a first canvas on the television and displaying, within the first canvas on the television, the web content; detecting, while displaying the web content in the first canvas, an activation of the option defined within the web content and associated with the additional multimedia content, wherein the activation of the option is configured to initiate playback of the additional multimedia content within the displayed web content; retrieving, through the television, the additional multimedia content; intercepting, through the user agent, the additional multimedia content and preventing the additional multimedia content from being displayed within the first canvas; activating a second canvas in response to detecting the activation of the option to initiate playback of the additional multimedia content, wherein the second canvas is different than and distinct from the first canvas; and playing back, on the television and in response to the detection of the activation of the option, the additional multimedia content within the second canvas while the web content continues to be displayed within the first canvas such that both the first canvas and the second canvas are active and displayed simultaneously.

Other embodiments provide systems for use in displaying content, comprising: means for receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; means for activating, by the user agent, a first canvas on the television; means for displaying, within the first canvas on the television, the web content; means for detecting, while displaying the web content in the first canvas, an activation of the option defined within the web content and associated with the additional multimedia content, wherein the activation of the option is configured to initiate playback of the additional multimedia content within the displayed web content; means for retrieving, through the television, the additional multimedia content; means for intercepting, through the user agent, the additional multimedia content and preventing the additional multimedia content from being displayed within the first canvas; means for activating a second canvas in response to detecting the activation of the option to initiate playback of the additional multimedia content, wherein the second canvas is different than and distinct from the first canvas; and means for playing back, on the television and in response to the detection of the activation of the option, the additional multimedia content within the second canvas while the web content continues to be displayed within the first canvas such that both the first canvas and the second canvas are active and displayed simultaneously.

Some embodiments provide computer program products comprising a tangible medium configured to embody a processor readable program as input to a processor and a program embodied in the medium configured to cause the processor to perform the steps of: receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; activating, by the user agent, a first canvas on the television and displaying, within the first canvas on the television, the web content; detecting, while displaying the web content in the first canvas, an activation of the option defined within the web content and associated with the additional multimedia content, wherein the activation of the option is configured to initiate playback of the additional multimedia content within the displayed web content; retrieving, through the television, the additional multimedia content; intercepting, through the user agent, the additional multimedia content and preventing the additional multimedia content from being displayed within the first canvas; activating a second canvas in response to detecting the activation of the option to initiate playback of the additional multimedia content, wherein the second canvas is different than and distinct from the first canvas; and playing back, on the television and in response to the detection of the activation of the option, the additional multimedia content within the second canvas while the web content continues to be displayed within the first canvas such that both the first canvas and the second canvas are active and displayed simultaneously.

A better understanding of the features and advantages of various embodiments of the present embodiments will be obtained by reference to the following detailed description and accompanying drawings which set forth exemplary illustrative embodiments in which principles of embodiments of the invention are utilized.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a simplified flow diagram of a process of controlling the display of multimedia content, in accordance with some embodiments.

FIG. 2 depicts a simplified block diagram of a system of displaying content, in accordance with some embodiments.

FIG. 3 shows an example of a television generating a first canvas and displaying exemplary web content within the first canvas, in accordance with some embodiments.

FIG. 4 shows a television with a user agent generating an exemplary first canvas with web content displayed within the first canvas and generating an exemplary separate second canvas displaying the additional multimedia content, in accordance with some embodiments.

FIG. 5 illustrates a system for use in implementing methods, techniques, devices, apparatuses, systems, servers, sources and the like in providing user interactive virtual environments in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

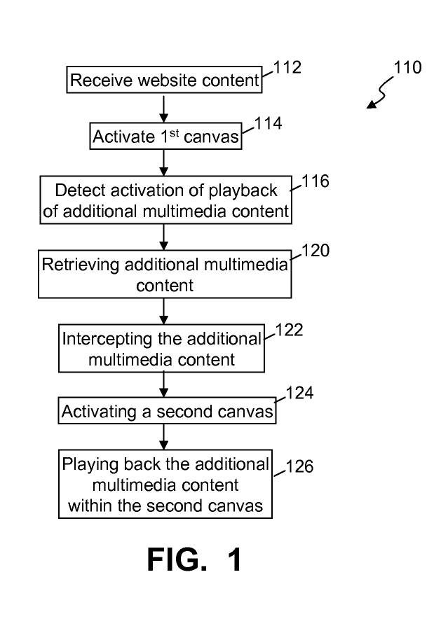

FIG. 1 depicts a simplified flow diagram of a process 110 of controlling the display of multimedia content, in accordance with some embodiments. In step 112, a user agent, which in some embodiments is part of a web browser application implemented on a television, receives web content at the television to be displayed on the television. The web content can contain substantially any relevant content, such as but not limited to, textual content, graphics content, image content, graphics, photographs, multimedia content, web content, links, options, triggers, or other such content, or combinations of two or more of such content.

In many instances, the web content includes an option or trigger defined or programmed within the web content and/or within metadata expressly associated with the content that when activated causes the user agent to initiate the retrieval and playback of additional multimedia content specifically associated with the option and further configured to be displayed within the displayed web content. For example, the displayed web content may include an option to automatically initiate playback of additional multimedia content, such as a video, an image, music or other relevant content, or option activated by a user to initiate playback of the additional multimedia content. Further, the video, image or visual content associated with the music is typically intended to be played back within a region of the displayed web content along other content of the web content, such as textual content.

In step 114, the user agent activates a first screen canvas on the television and displays the web content within the first screen canvas on the television. A screen canvas or screen canvas element, referred to below as a canvas for simplicity, identifies a portion of a screen or display of a television. The screen canvas allows for dynamic, scriptable rendering of shapes, bitmap images, and blocks of text. In some embodiments, canvases can put up different panels, where each panel can be a separate application and/or associated with separate content from separate inputs. Canvases can be distinct from each other. By way of example only, multiple canvases may simultaneously and independently represent sessions including different types of content and content received from one source or four different sources. For instance, each canvas may independently display live television programming, video-on-demand movies, Internet content such as a browser and web pages, streaming radio/video content, interactive games (via a local CD-ROM or hard drive or from a game server), JAVA applications, or the like services. For example, canvases may be used in displaying paragraphs and titles, building graphs, animations, games, and image composition, rendering video content, and/or other such content, and is not limited to canvas elements in accordance with HTML5.

The user agent may be in the form of software or a browser agent stored in the memory of the television, a set-top box, a gaming console, a media player device, or a remote server, and configured to receive user inputs, preferences, settings, and templates that govern relative sizes, locations, and priorities of the screen canvases on the television. For example, the user agent may be in the form of one or more browser windows and/or provide an icon-based selection menu displayed on the television that permits the user to enter inputs, preferences, and/or settings via a remote control, touch screen interface, consumer electronic device in communication with the television or the like.

In step 116, the user agent detects certain types of embedded content in and/or an activation of an option defined within the web content and/or within metadata of the content, while the web content is displayed in the first canvas. The embedded content comprises additional multimedia content to be displayed and/or played back. Typically, the web content dictates how the additional content is to be displayed, and further usually defines that the embedded content is to be displayed within the displayed web content in the first canvas. In some embodiments, the option within the web content is associated with displaying and/or playing back embedded content and/or additional multimedia content. The activation of the option is typically defined within the web content to initiate playback of the embedded content and/or the additional multimedia content within the web content displayed within the first canvas. In some implementations, a user may select an option to initiate the display or playback of the additional multimedia content. For example, there may be a hyperlink, a play button or other such option displayed in cooperation with a displayed icon, identifier or image associated to the additional multimedia content. The user often selects the option using a remote control, a mouse, a physical or graphical keyboard, or other such actions. In other implementations, the option to activate playback of the additional multimedia content may be in response to the web content being received and displayed through the user agent and television, through a script of the web content, or the like.

In step 120, the additional multimedia content is retrieved through the television. In some embodiments, the user agent initiates access to a remote source (e.g., via the Internet and/or other communication network) to request the additional multimedia content from the source. In other instances, the additional multimedia content is embedded within the web content and retrieved from the web content. In step 122, the user agent intercepts the additional multimedia content intended to be displayed with the web content and prevents the additional multimedia content from being displayed within the displayed web content. In step 124, the user agent activates a second canvas on the television in response to detecting the activation of the option to initiate playback of the additional multimedia content. The second canvas is different and distinct from the first canvas. In step 126, the user agent initiates playback, on the television and in response to the detection of the activation of the option, the additional multimedia content within the second canvas. Typically, the playback of the additional multimedia content occurs while the web content continues to be displayed within the first canvas such that both the first canvas and the second canvas are active and displayed simultaneously.

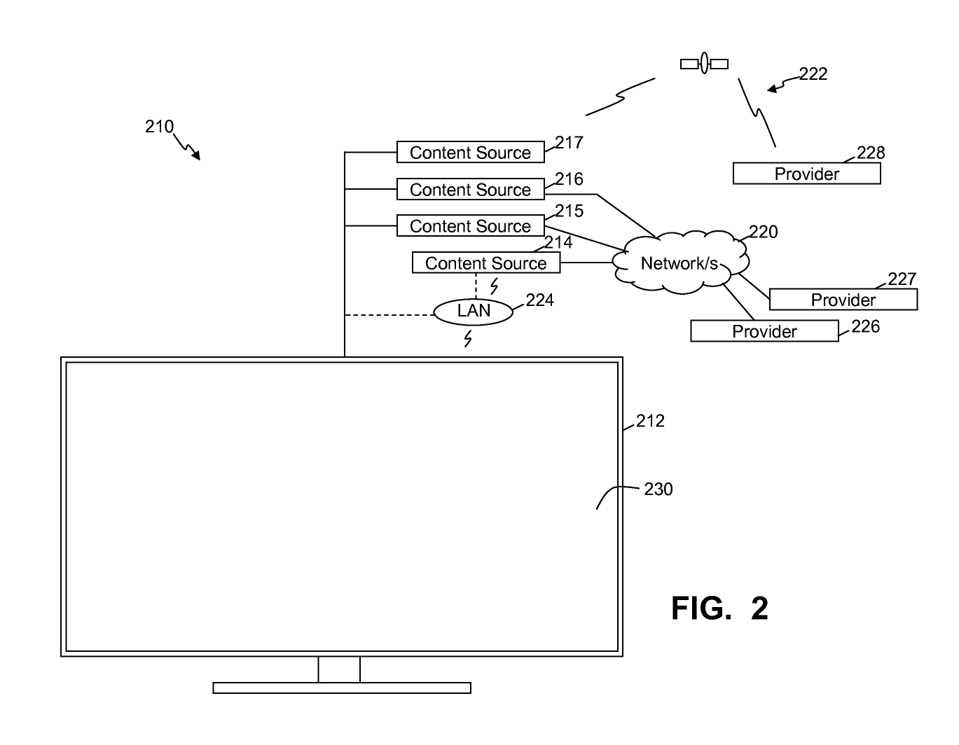

FIG. 2 depicts a simplified block diagram of a system 210 configured to display content, in accordance with some embodiments. The system 210 includes a television 212 and one or more content sources 214-217. The one or more content sources 214-217 are shows in FIG. 1 as exterior to the television 212; however, in some embodiments, one or more of the content sources 214-217 may be incorporated into and/or be part of the television 212. One or more of the content sources (e.g., content sources 214 and 217) may communicationally couple with content providers 226-228 over distributed communication networks 220, 222, 224 (e.g., the Internet, wide area network (WAN), satellite communication, local area network (LAN), broadcast and/or radio frequency communication, coaxial communication network/s, and/or other such communication networks, or a combination of two or more of such communication networks).

The content sources 214-217 are in wired and/or wirelessly communication with the television 212, and can be substantially any relevant content source, such as but not limited to a set-top-box, local router, digital media receiver, a Blu-ray and/or DVD player, a computer, a satellite broadcast service, a modem, a tablet device, a smart phone, or other such devices or combination of two or more of such devices that can communicate with and provide content to the television. Through the communication networks one or more of the content sources 214, 217 can communicate with the content providers 226-228 to obtain content, and forward the content (with or without processing) to the television 212. For simplicity, the description below, when relevant, generally refers to the content source 214 and generally refers to the content provider 226. However, it will be appreciated by those skilled in the art that the content source or content provider can be substantially any relevant content source or content provider or combination of content sources or content providers.

In operation, the television 212 is configured to receive content from one or more of the content sources and play back and/or display the content. The content can be substantially any relevant content, such as but not limited to television broadcast content, on-demand content, streamed content, web content, downloaded content, DVD content, Blu-ray content, locally stored content, or other such content or combinations of such content. Further, content from one content source 214 may access and/or cause retrieval and playback of content from another content source 214.

As described above with respect to FIG. 1, in some embodiments, a user agent of a web browser of the television 112 can access and display web content or other relevant network content that includes an option (e.g., a link, a menu option, button, option, etc.) that allows access to additional multimedia content through the web content. The web content is typically configured with one or more scripts that identify the one or more content providers 226 from which to retrieve the additional multimedia content, and in some implementations further dictates control of the display or playback of the additional multimedia content within the displayed web content.

With the advancement in display technology and signal processing technologies, however, the television 212 can be configured with a relatively large display 230. Accordingly, in some embodiments, the television 212 can utilize the available display space to improve users' playback experiences. In some embodiments, the television 212 can be what is generally referred to as a “4K television,” an “8K television,” or other such relevant televisions that have large displays 230 with greater number of pixels providing greater resolution. The “4K television” generally is a television that has a horizontal resolution on the order of 4,000 pixels (e.g., resolution of 3840×2160, 4096×2160 or other such enhanced resolutions), and typically greater than 3600 pixels. Accordingly, in some embodiments, the television is considered an ultra high definition television having a horizontal number of pixels of at least 3600 pixels, where the first canvas can be displayed over a portion of a display of the television and the second canvas is displayed over a second portion of the display of the television such that the second canvas does not overlap the first canvas.

Further, many of these advanced televisions are configured to provide canvases into which content is to be configured and played back. For example, in some embodiments, the television 212 can be configured to operate in accordance with HTML5 markup language, which allows the television to utilize canvases when displaying content. Additionally, because of the size of the display 230 of the relatively large television 212, multiple canvases can be displayed without adversely interfering with the playback experience of content. For example, with a 108 inch display 230 (measured diagonally) multiple canvases can be displayed with different content, which may be related or unrelated. In some embodiments, the television 212 can be configured with multiple tuners, decoders, signal processors and/or other such functionality to allow the television 212 to simultaneously receive and display content from multiple different content sources 214.

Further, the television 212 can include a code and/or programming to implement a web browser allowing the television 212 and/or the user to access, display and interact with web content. Further, the web browser includes a user agent that in part controls the display of web content.

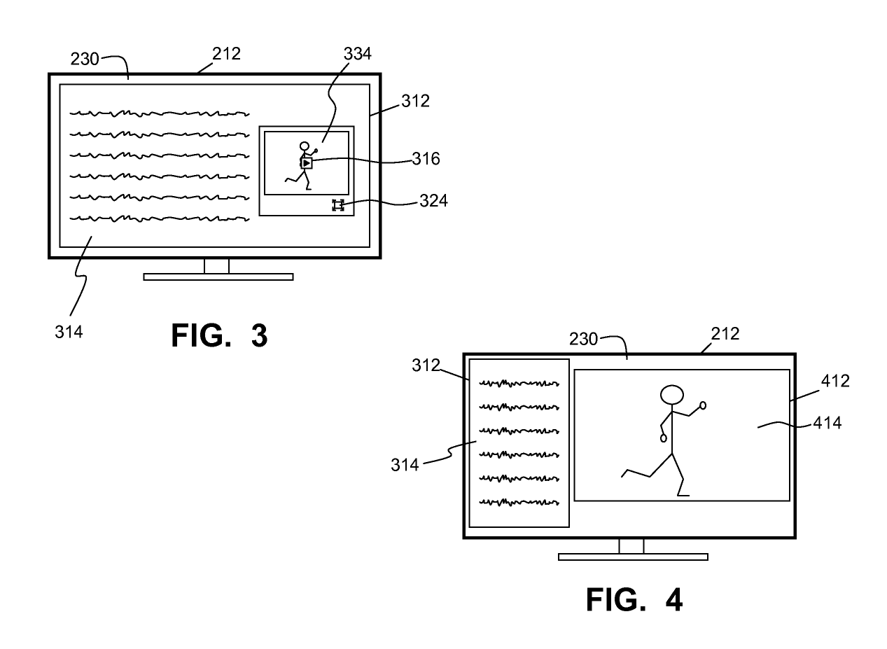

FIG. 3 shows an example of a television 212 generating a first canvas 312 and displaying exemplary web content 314 within the first canvas 312, in accordance with some embodiments. Again, the web content 314 can include substantially any relevant content, such as text, graphics, animation, video, pictures and other such content. The appearance and layout of the displayed web content is typically defined within the web content and/or metadata of the web content, and often includes scripts that are configured to cause the web content to be presented to the user. Some web content include options or user activated controls 316 that allow additional multimedia content to be displayed in cooperation with the web content. In other implementations, the option 316 may automatically be activated as part of the display of the web content.

In some embodiments, the option 316 can include a link to access a content provider 226 to retrieve additional multimedia content to be played back within the web content 214. One or more of the scripts (e.g., JavaScripts) are typically activated in response to detecting the activation of the option. In some embodiments, the user agent can activate and/or implement one or more of the scripts. The scripts can, for example, identify the additional multimedia content, identify the relevant content provider 226 (or at least access to the content provider, such as a website or the like), retrieve the additional multimedia content, and implement other such functionality. The scripts further typically dictate that the additional multimedia content 320 is to be displayed or played back within the web content, where the developer of the web content intends for the additional multimedia content to be displayed within the web content and specifically programs the scripts and/or parameters of the web content to cause the additional multimedia content to be displayed within the web content.

In some embodiments, however, the user agent is configured to override, embellishes or reinterpret intended implementations of one or more scripts, defined within the web content and configured to implement playback of the additional multimedia content within the displayed website, with alternate scripts and/or programming in intercepting the additional multimedia content before it is displayed within the web content and the canvas 312. The intercepted content can then be redirected to be displayed in a second canvas. In some instances, web content and/or the content received in response to the activation of the option to retrieve and playback the additional multimedia content includes one or more tags, identifiers or other relevant indications of the additional multimedia content. In some embodiments, the user agent utilizes the one or more tags in identifying the additional multimedia content. Additionally, in some embodiments, a rendering engine determines which of one or more tag from the web content correspond to multimedia actually to be rendered. The rendering engine can be part of the user agent or operated in cooperation with the user agent. In some embodiments, the output of the rendering engine diverts the additional multimedia content to the separate canvas on the separate area of the television display screen based on one or more settings and/or options in the user agent. As such, the rendering engine and/or user agent utilize the tags to intercept and extract the additional multimedia content and prevent the additional multimedia content from being displayed within the web content. Accordingly, the user agent reinterprets and/or overrides the intent of the web content and/or web content developer to display the additional multimedia content within the separate canvas. Alternatively, the intercepting of the multimedia content does not occur upon initial playback, and instead is activated in response to a user selecting an option to shift to a full screen view or other larger view. In some embodiments, a user can move or “drag” the additional multimedia content out of web content to be view in a separate canvas. In such scenarios, the user agent typically does employ an option setting to redirect the additional multimedia content to the separate canvas.

Further, in some embodiments, the user agent in intercepting the additional multimedia content reinterprets intended implementations of and/or overrides one or more display parameters defined within the web content dictating the display of the additional multimedia content within the website, and directs the additional multimedia content to be displayed within the second canvas. For example, the user agent can be configured to override and/or reinterpret scripts and parameters associated with an option programmed in the web content associated with intended playback control of the additional multimedia content to display the additional multimedia content in a full screen view while redirecting the additional multimedia content to be displayed into the second canvas and in accordance with alternative parameters overriding and/or reinterpreting the intended implementation of a full screen view option programmed within the web content and associated with intended playback control of the additional multimedia content. Further, the user agent applies alternative display parameters specified to display the additional multimedia content relative to the second canvas and within an available area of the display 230 and/or as otherwise specified. For example, in some embodiments, a display manager is further included that manages the display 230 and the organization of the displayed content. In some implementations, the display manager is part of the user agent, while in other embodiments, the display manager merely provides information to the user agent, such as designating display parameters that define the location and size for generating the second canvas and/or displaying the additional multimedia content. Further, in some embodiments, the display of the multimedia content is automatically rescaled to fit within the second canvas.

The user agent, in some embodiments, overrides and/or reinterprets intended implementations of the positioning parameters and/or components of the web content defined within the web content and specifying where the additional multimedia content is to be displayed. The user agent alters content, parameters and/or information used by scripts in controlling the display of the multimedia content to correspond with the second canvas and to re-position and/or define a new position to a new location on the display 230 within the second canvas. Alternatively or additionally, the user agent overrides, embellishes and/or reinterprets one or more scripts of the web content intended to display the additional content with alternative scripts that direct the additional multimedia content to the second canvas and define positioning on the display 230 and within the second canvas.

The option 316 to retrieve and playback the multimedia content may be displayed while the web content 314 is displayed. In other instances, the option 316 may be displayed in response to a user hovering a pointing device over an identifier or indication (image) of the availability of the additional multimedia. Further, in some embodiments, the user agent may embellish and/or reinterpret the intended implementations of one or more scripts of the web content to display one or more alternative options instead of the option defined within the web content. For example, the displayed option 316 may include one or more options, such as an option to playback the additional multimedia content into a separate second canvas, to playback the additional multimedia content with the web content 314, to playback the additional multimedia content of the full area of the display 230 and/or other such options.

In some implementations, web content 314 may include a full screen option 324 or other such option or command that is configured to display the additional multimedia content over an entire area of the display and/or enlarge the area of the display occupied by the additional multimedia content as it is being played back. Typically, upon activation of this full screen option 324, usually by the user selecting the option, the remainder of the web content is occluded or hidden by the displayed additional multimedia content.

In some embodiments, the user agent of the browser functionality is further configured to override and/or reinterpret the intended implementations of the one or more scripts configured to implement the full screen option 324 and prevents the additional multimedia content from being displayed full screen, and/or prevents the additional multimedia content from occluding the remainder of the web content.

FIG. 4 shows an example of a television 212 with a user agent generating an exemplary first canvas 312 with web content 314 displayed within the first canvas 312 and generating an exemplary separate second canvas 412 displaying the additional multimedia content 414, in accordance with some embodiments. The first canvas 312 is displayed over a first portion of the display 230 of the television 212 and the second canvas 412 is displayed over a second portion of the display of the television. The second canvas 412 is typically displayed such that the second canvas does not overlap the first canvas 312 or obstruct the first web content 314. The first canvas 312 can be maintained active such that the web content is accessible to the user and configured to continue to be interacted with by the user while the second canvas 412 is active and playing back the additional multimedia content 414 within the second canvas.

In some embodiments, the television 212 and/or the user agent includes a display manager that tracks the one or more canvases and content displayed on the display 230. The display manager can modify one or more canvases and/or the display of content within one or more canvases to optimize utilization of the real estate of the display 230 and/or free up one or more areas of the display 230 into which one or more additional canvases can be generated. In some embodiments, the display manager further takes into consideration the type of content being displayed and/or to be displayed in determining how to utilize the area of the display 230. For example, when the additional multimedia content is video content, the display manager may recognize that the additional multimedia content is video content (e.g., through identifiers, metadata, type of file(s), or the like) and resize and/or move the first canvas 312 to free up space on the display 230 to be utilized by the second canvas 412 and the display of the additional multimedia content 414. Similarly, when the content to be displayed includes textual content, the display manager, with knowledge of the total size and area of the display 230 and the content being displayed, can attempt to ensure that the display area provided for the textual content is sufficiently large so that a user (with average visual acuity for a human adult) at a predefined distance (e.g., 12 ft) or range (e.g., 10-15 ft) can still read the textual content. For example, when displaying web content 314 that includes textual content, the display manager can take advantage of the size of the display 230 and resize the first canvas 312 and/or the web content 314 without interfering with a user's ability to accurately view the web content while still allowing the second canvas 412 and the additional multimedia content 414 to be displayed with sufficient size to allow an enjoyable playback of the additional multimedia content.

Further, in some embodiments, the display manager may dictate or determine that the additional multimedia content 414 should be displayed over a larger area of the display 230 than the first content (e.g., the web content 314). Accordingly, the display manager can reposition and/or resize the displayed web content 314 freeing up additional areas of the display 230 to be utilized in displaying the additional multimedia content 414. In some embodiments, the display manager and/or the user agent free up area on the display, in response to detecting the activation of the option and typically prior to the activation of the second canvas, by resizing the first canvas and reformatting the web content to be displayed within the first canvas. The reformatting can include identifying an image representing the additional multimedia content and indicating an availability of the additional multimedia content, and removing the image representing the additional multimedia content such that the web content is displayed without the image. Further, in some embodiments, the display of the multimedia content is automatically rescaled to fit within the second canvas that is activated within the identified available area of the television display 230. In some embodiments, the rescaling adjusts the resolution of the multimedia content to take full advantage of the native resolution of the display, and which is typically determined by the size of the canvas to which the content is transferred. Additionally, in some embodiments, the user agent provides a translation of events that are position related, detected in the second canvas, to equivalent position related events in the first canvas.

In some embodiments, the display manager utilizes predefined conditions and/or parameters in determining how to position and/or organize the one or more canvases 312, 412 over the display 230 of the television. Again, the display manager may take into consideration the type of content being displayed in determining positioning and/or resizing. Additionally and/or alternatively, the display manager may take into consideration user preferences and/or profile information, which may have been specified by a user and/or learned by the display manager (e.g., based on a user's previous interactions with canvases in resizing and/or positioning the one or more canvases).

In some embodiments, the display manager (or user agent) is configured to identify, in response to the activation of the option to initiate the display of the additional multimedia content, an area within the displayed web content intended to display, through the first canvas, the additional multimedia content. This identified area can then be freed up to be utilized by the second canvas and/or the rearranged web content as it continues to be displayed in the first canvas. Additionally or alternatively, the display manager can identify within the web content an image representative of the additional multimedia content. For example, the web content may contain an image 334 (see FIG. 3) that represents the additional multimedia content and typically notifies the user of the access to the additional multimedia content. As such, the display manager can reconfigure the web content to remove the representative image 334 freeing up space on the display 230. Additionally, the remainder of the web content can be rearranged as it continues to be displayed in the first canvas as a result of the removal of the representative image 334.

Still further, in some embodiments, the display manager may be limited by predefined arrangements, organizations and/or templates that dictate how content should be distributed over the display 230. For example, templates may divide the display 230 vertically into two halves, horizontally into two halves, into quadrants, into two halves with one of the halves further divided in halve or fourths, a first area may be defined to occupy ⅔ of the area of the display while the remainder of available space may be divided into one or more additional areas, and other such predefined configurations. Additionally, the templates may be predefined for certain types of content and/or relationships between content (e.g., textual content and video content, two different video content, etc.), and/or certain areas of templates may be predefined and/or intended for certain types of content. Still further, the display manager can implement automatic resizing of the first canvas upon determination an amount of area of the display 230 the second canvas is to occupy, and/or in response to detecting a resizing of the second canvas, another canvas and/or the displayed content of a canvas (e.g., a user resizing).

Additionally, in some embodiments, the redirecting of the additional multimedia content 414 to a second canvas 412 further includes the disassociation of the additional multimedia content from the web content 314. Typically, the web content and the additional multimedia content are associated so that should the user move away from the web content the user no longer has access to the additional multimedia content. For example, should the user shift to a different website, access to and/or playback of the additional multimedia content is lost. In some embodiments, however, the user agent in generating the second canvas 412 disassociates the additional multimedia content from the first canvas 312 and the web content 314 displayed in the first canvas. As such, the user can return to the first canvas 312 and navigate away from the web content 314 while still accessing and displaying the additional multimedia content 414. In some embodiments, the user agent creates a separate session with which the second canvas is associated. Through the separate sessions the first and second canvases can be separately controlled and interacted with without altering the operation of the other canvas. This can include, for example, allowing a first session (e.g., which may be associated with the first canvas 312) to be moved to a separate consumer electronic device (e.g., to a smart phone in communication with the television 212 via a wired/wireless local area network) while the second canvas continues to be displayed on the television 212. Further, upon moving the first canvas to the separate consumer electronic device, the user agent and/or the display manager, in some embodiments, can resize the second canvas 412 and/or the displayed additional multimedia content 414 to utilize freed up portions of or all of the display 230.

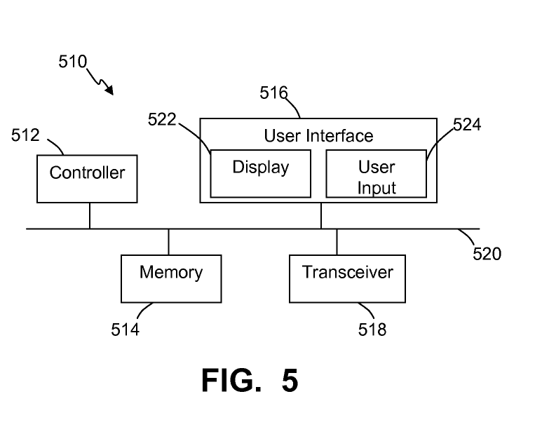

The methods, techniques, systems, devices, services, servers, sources and the like described herein may be utilized, implemented and/or run on many different types of devices and/or systems. Referring to FIG. 5, there is illustrated a system 510 that may be used for any such implementations, in accordance with some embodiments. One or more components of the system 510 may be used for implementing any system, apparatus or device mentioned above or below, or parts of such systems, apparatuses or devices, such as for example any of the above or below mentioned televisions 212, content sources 214-217, content providers 226-228, user agent, display manager, display 230 of the television, signal processing system, signal processors, decoders, encoders, image processing system, graphics generator system, controller(s), and the like. However, the use of the system 510 or any portion thereof is certainly not required.

By way of example, the system 510 may comprise a controller or processor module 512, memory 514, a user interface 516, and one or more communication links, paths, buses or the like 520. A power source or supply (not shown) is included or coupled with the system 510. The controller 512 can be implemented through one or more processors, microprocessors, central processing unit, logic, local digital storage, firmware and/or other control hardware and/or software, and may be used to execute or assist in executing the steps of the methods and techniques described herein, and control various communications, programs, content, listings, services, interfaces, etc. The user interface 516 can allow a user to interact with the system 510 and receive information through the system. In some instances, the user interface 516 includes a display 522, which can be display 230 and/or other such display, and/or one or more user inputs 524, such as a remote control, keyboard, mouse, track ball, game controller, buttons, touch screen, etc., which can be part of or wired or wirelessly coupled with the system 510. Similarly, in some embodiments, the user interface 516 or portions thereof can be implemented in secondary consumer electronic devices in communication with the controller 512 (e.g., controller of the television 212, controller of a content source 214-217 and the like), such as a tablet, smart phone, computer, laptop, or other such relevant device that can communicate with the controller 512.

Typically, the system 510 further includes one or more communication interfaces, ports, transceivers 518 and the like allowing the system 510 to communication over a distributed network, a local network, the Internet, communication link 520, other networks or communication channels with other devices and/or other such communications. Further the transceiver 518 can be configured for wired, wireless, optical, fiber optical cable or other such communication configurations or combinations of such communications.

The system 510 comprises an example of a control and/or processor-based system with the controller 512. Again, the controller 512 can be implemented through one or more processors, controllers, central processing units, logic, software and the like. Further, in some implementations the controller 512 may provide multiprocessor functionality.

The memory 514, which can be accessed by the controller 512, typically includes one or more processor readable and/or computer readable media accessed by at least the controller 512, and can include volatile and/or nonvolatile media, such as RAM, ROM, EEPROM, flash memory and/or other memory technology. Further, the memory 514 is shown as internal to the system 510; however, the memory 514 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. The memory 514 can store code, software, executables, scripts, data, content, multimedia content, web content, programming, programs, media stream, media files, textual content, identifiers, log or history data, user information, user profiles, and the like.

One or more of the embodiments, methods, processes, approaches, and/or techniques described above or below may be implemented in one or more computer programs executable by a processor-based system. By way of example, such a processor based system may comprise the processor based system 510, a television, an IP enabled television, a set-to-box, a Blu-ray player, an IP enabled Blu-ray player, a DVD player, a computer, entertainment system, gaming console, graphics workstation, tablet, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for displaying the additional multimedia content 414. As another example, such computer programs may be used for implementing any type of device, system or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a tangible medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; activating, by the user agent, a first canvas on the television and displaying, within the first canvas on the television, the web content; detecting, while displaying the web content in the first canvas, an activation of the option defined within the web content and associated with the additional multimedia content, wherein the activation of the option is configured to initiate playback of the additional multimedia content within the displayed web content; retrieving, through the television, the additional multimedia content; intercepting, through the user agent, the additional multimedia content and preventing the additional multimedia content from being displayed within the first canvas and/or within the web content; activating a second canvas in response to detecting the activation of the option to initiate playback of the additional multimedia content, wherein the second canvas is different than and distinct from the first canvas; and playing back, on the television and in response to the detection of the activation of the option, the additional multimedia content within the second canvas while the web content continues to be displayed within the first canvas such that both the first canvas and the second canvas are active and displayed simultaneously.

Other embodiments provide one or more computer-readable storage mediums storing one or more computer programs configured for use with a computer simulation, the one or more computer programs configured to cause a computer and/or processor based system to execute steps comprising: receiving, through a user agent of a television, first multimedia content at the television to be displayed on the television, wherein the first multimedia content comprises an option that when activated causes the retrieval and playback of additional multimedia content specifically associated with the option and configured to be displayed within a sub-window displayed within the first multimedia content; the first user agent activating a first canvas on the television and playing back, within the first canvas on the television, the first multimedia content; receiving, in response to the playing back of the first multimedia content in the first canvas, an activation of the option; retrieving the additional multimedia content; intercepting the additional multimedia content and preventing the additional multimedia content from being displayed within the sub-window of the first multimedia content; activating a second canvas that is different from and distinct from the first canvas; and displaying, on the television, the additional multimedia content within the second canvas while the first multimedia content continues to be played back within the first canvas such that both the first canvas and the second canvas are active and displayed simultaneously.

Many of the functional units described in this specification have been labeled as systems, devices, agent, manager or modules, in order to more particularly emphasize their implementation independence. For example, a system, device, agent or manager may be implemented as a hardware circuit comprising custom VLSI circuits or gate arrays, off-the-shelf semiconductors such as logic chips, transistors, or other discrete components. A system, device, agent or manager may also be implemented in programmable hardware devices such as field programmable gate arrays, programmable array logic, programmable logic devices or the like.

Systems, devices, agents or managers may also be partially or fully implemented in software for execution by various types of processors. An identified system, device, agent or manager of executable code may, for instance, comprise one or more physical or logical blocks of computer instructions that may, for instance, be organized as an object, procedure, or function. Nevertheless, the executables of an identified system, device, agent or manager need not be physically located together, but may comprise disparate instructions stored in different locations which, when joined logically together, comprise the system, device, agent or manager and achieve the stated purpose for the system, device, agent or manager.

Indeed, a system, device, agent or manager of executable code could be a single instruction, or many instructions, and may even be distributed over several different code segments, among different programs, and across several memory devices. Similarly, operational data may be identified and illustrated herein within systems, devices, agents or managers, and may be embodied in any suitable form and organized within any suitable type of data structure. The operational data may be collected as a single data set, or may be distributed over different locations including over different storage devices, and may exist, at least partially, merely as electronic signals on a system or network.

Some embodiments provide methods of displaying additional multimedia content. At least some of these embodiments receive, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; activate, by the user agent, a first canvas on the television and displaying, within the first canvas on the television, the web content; detect, while displaying the web content in the first canvas, an activation of the option defined within the web content and associated with the additional multimedia content, wherein the activation of the option is configured to initiate playback of the additional multimedia content within the displayed web content; retrieve, through the television, the additional multimedia content; intercept, through the user agent, the additional multimedia content and preventing the additional multimedia content from being displayed within web content and/or the first canvas; activate a second canvas in response to detecting the activation of the option to initiate playback of the additional multimedia content, wherein the second canvas is different than and distinct from the first canvas; and playback, on the television and in response to the detection of the activation of the option, the additional multimedia content within the second canvas while the web content continues to be displayed within the first canvas such that both the first canvas and the second canvas are active and displayed simultaneously.

Further, some embodiments free up area on the display, in response to detecting the activation of the option and prior to the activation of the second canvas, and resize the first canvas and reformat the web content to be displayed within the resized first canvas. The reformatting can comprise identifying an image representing the additional multimedia content and indicating an availability of the additional multimedia content, and removing the image representing the additional multimedia content such that the web content is displayed without the image representing the additional multimedia content.

In some embodiments, the retrieval of the additional multimedia content includes receiving content comprising the additional multimedia content. The rendering engine in cooperation with the user agent intercepts the additional multimedia content based on the one or more tags selected or identified through logic and/or code. The tags can be used to identify the additional multimedia content and extract the additional multimedia content from the retrieved content. Further, in intercepting the additional multimedia content, one or more display parameters defined within the web content dictating the display of the additional multimedia content within the displayed web content can be overridden or altered, for example, with alternative parameters and/or scripts to display the additional multimedia content within the second canvas.

Some embodiments further link the second canvas with the first canvas. The linking of the canvases, in some implementations, allows the user agent and/or display manager to automatically resize the first canvas without further user interaction in response to detecting a resizing of the second canvas. Similarly, user agent and/or display manager may also be configured to automatically resize the second canvas without further user interaction in response to detecting a resizing of the first canvas. The resizing may be in response to the activation of the second canvas, user interaction (e.g., user manually resizing a canvas or content displayed within a canvas), one or more additional canvases being activated, the display of additional content within a canvas, detection of a change in a type of content being displayed in a canvas (e.g., different web content accessed through the first canvas), or other such resizing.

Some embodiments provide methods of displaying content. These method receive first multimedia content at a television to be displayed on the television, wherein the first multimedia content comprises an option that when activated causes the retrieval and playback of additional multimedia content specifically associated with the option and configured to be displayed within a sub-window displayed within the first multimedia content; playback, within a first canvas on the television, the first multimedia content; receive, in response to the playing back of the first multimedia content in the first canvas, an activation of the option; retrieve the additional multimedia content; intercept the additional multimedia content and preventing the additional multimedia content from being displayed within the sub-window of the first multimedia content; activate a second canvas that is different from and distinct from the first canvas; and display, on the television, the additional multimedia content within the second canvas while the first multimedia content continues to be played back within the first canvas such that both the first canvas and the second canvas are active and displayed simultaneously.

Further, some embodiments free up area on the display, typically in response to detecting the activation of the option, by resizing the first canvas and reformatting the web content to be displayed within the resized first canvas. In some implementations, the reformatting further includes identifying an image representing the additional multimedia content and indicating an availability of the additional multimedia content, and removing the image representing the additional multimedia content such that the web content is displayed without the image representing the additional multimedia content. Additionally or alternatively, some embodiments identify, in response to the activation of the second canvas, an area within the displayed web content intended to display through the first canvas the additional multimedia content. The web content can then be rearranged as it continues to be displayed in the first canvas such that the area intended to display the additional multimedia content is removed and remaining web content is rearranged according to the removed portion intended to display the additional multimedia content.

Further embodiments provide systems that display content. Some of these embodiments include means for receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content; means for activating, by the user agent, a first canvas on the television and displaying, within the first canvas on the television, the web content; means for detecting, while displaying the web content in the first canvas, an activation of the option defined within the web content and associated with the additional multimedia content, wherein the activation of the option is configured to initiate playback of the additional multimedia content within the displayed web content; means for retrieving, through the television, the additional multimedia content; means for intercepting, through the user agent, the additional multimedia content and preventing the additional multimedia content from being displayed within web content; means for activating a second canvas in response to detecting the activation of the option to initiate playback of the additional multimedia content, wherein the second canvas is different than and distinct from the first canvas; and means for playing back, on the television and in response to the detection of the activation of the option, the additional multimedia content within the second canvas while the web content continues to be displayed within the first canvas such that both the first canvas and the second canvas are active and displayed simultaneously.

While the invention herein disclosed has been described by means of specific embodiments, examples and applications thereof, numerous modifications and variations could be made thereto by those skilled in the art without departing from the scope of the invention set forth in the claims.

1. A method of displaying content, the method comprising:
receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content;
activating, by the user agent, a first canvas on the television and displaying, within the first canvas on the television, the web content;
detecting, while displaying the web content in the first canvas, an activation of the option defined within the web content and associated with the additional multimedia content, wherein the activation of the option is configured to activate one or more scripts defined within the web content that when implemented are configured to initiate playback of the additional multimedia content such that the additional multimedia content is intended to be played back within the displayed web content;
retrieving, through the television, the additional multimedia content;
intercepting, through the user agent, the additional multimedia content;
overriding the one or more scripts and preventing the additional multimedia content from being displayed within the first canvas;
activating a second canvas in response to detecting the activation of the option to initiate playback of the additional multimedia content, wherein the second canvas is different than and distinct from the first canvas; and
playing back, on the television and in response to the detection of the activation of the option and in overriding the one or more scripts, the additional multimedia content within the second canvas while the web content continues to be displayed within the first canvas such that both the first canvas and the second canvas are active and displayed simultaneously.

2. The method claim 1, wherein the retrieving the additional multimedia content comprises receiving content comprising the additional multimedia content; and
wherein the intercepting the additional multimedia content comprises:
parsing retrieved content comprising the multimedia content;
identifying, as a result of the parsing, one or more tags within the retrieved content that identify the additional multimedia content within the retrieved content; and
extracting the additional multimedia content.

3. The method of claim 1, wherein the overriding comprises overriding intended implementations of one or more display parameters defined within the web content dictating the display of the additional multimedia content within the displayed web content, and applying alternative parameters configured to direct the additional multimedia content to be displayed within the second canvas.

4. The method of claim 3, wherein the overriding the intended implementations of the one or more display parameters further comprises overriding an intended implementation of a full screen view option programmed within the web content and associated with intended playback control of the additional multimedia content.

5. The method of claim 4, wherein the television is an ultra high definition television having a horizontal number of pixels of at least 3600 pixels, wherein the first canvas is displayed over a portion of a display of the television and the second canvas is displayed over a second portion of the display of the television such that the second canvas does not overlap the first canvas.

6. The method of claim 1, wherein the overriding comprises overriding intended implementations of the one or more scripts, defined within the web content and configured to implement playback of the additional multimedia content within the displayed web content, and applying programming to redirect the additional multimedia content to be displayed in the second canvas.

7. The method of claim 1, further comprising:
disassociating the additional multimedia content from the web content, and maintaining the first canvas active such that the web content is accessible to the user and configured to continue to be interacted with by the user while the second canvas is active and playing back the additional multimedia content within the second canvas.

8. The method of claim 1, further comprising:
freeing up area on a display of the television, in response to detecting the activation of the option, wherein the freeing up the area on the display comprising resizing the first canvas and reformatting the web content to be displayed within the resized first canvas;
wherein the activating the second canvas comprises activating the second canvas to utilize at least some of the freed up area on the display such that the additional multimedia content is played back on the at least the portion of the freed up area on the display.

9. A system for use in displaying content, the system comprising:
means for receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content;
means for activating, by the user agent, a first canvas on the television;
means for displaying, within the first canvas on the television, the web content;
means for detecting, while displaying the web content in the first canvas, an activation of the option defined within the web content and associated with the additional multimedia content, wherein the activation of the option is configured to activate one or more scripts defined within the web content that when implemented are configured to initiate playback of the additional multimedia content such that the additional multimedia content is intended to be played back within the displayed web content;
means for retrieving, through the television, the additional multimedia content;
means for intercepting, through the user agent, the additional multimedia content;
means for overriding the one or more scripts and preventing the additional multimedia content from being displayed within the first canvas;
means for activating a second canvas in response to detecting the activation of the option to initiate playback of the additional multimedia content, wherein the second canvas is different than and distinct from the first canvas; and
means for playing back, on the television and in response to the detection of the activation of the option and in overriding the one or more scripts, the additional multimedia content within the second canvas while the web content continues to be displayed within the first canvas such that both the first canvas and the second canvas are active and displayed simultaneously.

10. The system claim 9, wherein the means for intercepting the additional multimedia content comprises
means for identifying one or more tags within the retrieved content that identify the additional multimedia content within the retrieved content, and means for extracting the additional multimedia content based on the one or more tags.

11. The system of claim 9, wherein the means for overriding is further configured to override intended implementations of one or more display parameters defined within the web content dictating the display of the additional multimedia content within the displayed web content, and apply alternate parameters configured to direct the additional multimedia content to be displayed within the second canvas.

12. The system of claim 11, wherein the means for overriding the intended implementation of the one or more display parameters further comprises means for overriding an intended implementation of a full screen view option programmed within the web content and associated with intended playback control of the additional multimedia content.

13. The system of claim 9, wherein the means for overriding is configured to override intended implementations of the one or more scripts, defined within the web content and configured to implement playback of the additional multimedia content within the displayed web content, and apply programming to redirect the additional multimedia content to be displayed in the second canvas.

14. A computer program product comprising a tangible medium configured to embody a processor readable program as input to a processor and a program embodied in the medium configured to cause the processor to perform the steps of:
receiving, through a user agent of a web browser application implemented on a television, web content at the television to be displayed on the television, wherein the web content comprises an option defined within the web content that when activated causes the retrieval and playback of additional multimedia content specifically associated with the option and configured to be displayed within the displayed web content;
activating, by the user agent, a first canvas on the television and displaying, within the first canvas on the television, the web content;
detecting, while displaying the web content in the first canvas, an activation of the option defined within the web content and associated with the additional multimedia content, wherein the activation of the option is configured to activate one or more scripts defined within the web content that when implemented are configured to initiate playback of the additional multimedia content such that the additional multimedia content is intended to be played back within the displayed web content;
retrieving, through the television, the additional multimedia content;
intercepting, through the user agent, the additional multimedia content;
overriding the one or more scripts and preventing the additional multimedia content from being displayed within the first canvas;
activating a second canvas in response to detecting the activation of the option to initiate playback of the additional multimedia content, wherein the second canvas is different than and distinct from the first canvas; and
playing back, on the television and in response to the detection of the activation of the option and in overriding the one or more scripts, the additional multimedia content within the second canvas while the web content continues to be displayed within the first canvas such that both the first canvas and the second canvas are active and displayed simultaneously.

15. The computer program product in accordance with claim 14,
wherein the step of intercepting the additional multimedia content comprises
identifying one or more tags within the retrieved content that identify the additional multimedia content within the retrieved content, and extracting the additional multimedia content based on the one or more tags.

16. The computer program product in accordance with claim 14, wherein the step of overriding comprises overriding intended implementations of one or more display parameters defined within the web content dictating the display of the additional multimedia content within the displayed web content, and applying alternate parameters configured to direct the additional multimedia content to be displayed within the second canvas.

17. The computer program product in accordance with claim 16, wherein the step of overriding the intended the implementations of the one or more display parameters further comprises overriding a full screen view option programmed within the web content and associated with intended playback control of the additional multimedia content.

18. The computer program product in accordance with claim 14, wherein the step of overriding comprises overriding intended implementations of the one or more scripts, define within the web content and configured to implement playback of the additional multimedia content within the displayed web, and applying programming to redirect the additional multimedia content to be displayed in the second canvas.

19. The method of claim 1, further comprising:
playing back, on the television, the additional multimedia content within the first canvas upon initially receiving the additional multimedia content; and
detecting a selection of an option by a user; and
activating the intercepting and the overriding in response to the detection of the selection of the option, such that playing back of the additional multimedia content within the second canvas is in response to the detection of the selection of the option by the user.

20. The method of claim 19, wherein the option comprises an option to implement a display of the additional content in a full screen view; and
activating the intercepting and the overriding the first script configured to cause the additional content to be displayed in a full screen view, and activating the playing back of the additional content in the second canvas such that the second canvas is displayed over only a portion of the display and overriding the script to display the additional content in the full screen view.
